(19) United States
(12) Patent Application Publication
(10) Pub. No.: US 2017/0327394 A1
(43) Pub. Date: Nov. 16, 2017

(54) NOVEL FACILITY FOR TREATING WASTE WATER

(71) Applicant: SUEZ INTERNATIONAL, Paris La Defense Cedex (FR)

(72) Inventor: Gildas MANIC, PARIS (FR)

(21) Appl. No.: 15/529,810

(22) PCT Filed: Dec. 16, 2015
(86) PCT No.: PCT/IB2015/059671

§ 371 Date: May 25, 2017

(30) Foreign Application Priority Data
Dec. 19, 2014 (FR) 14 62900

(51) Int. Cl. C02F 3/12; C02F 3/08; C02F 3/00

(52) U.S. Cl. CPC C02F 3/1215; C02F 3/1247; C02F 3/1221; C02F 3/082; C02F 3/00

(57) ABSTRACT

Disclosed is a facility for treating waste water of municipal or industrial origin, in particular a facility for primary treatment of the water, including a biological contact tank equipped with biological rotating discs, which is connected upstream of a ballasted-floc physiochemical decanter, the decanter being at least made up of a coagulation zone, a flocculation zone, a lamellar decanting zone and a thickening zone and an external circuit allowing the recirculation of the sludge thickened in the thickening zone to the flocculation zone and the biological contact tank.

The present invention concerns the treatment of waste water of municipal or industrial origin, in particular the primary treatment of water, which may be performed before discharge to the receiving environment or upstream of a biological or physicochemical treatment.

The pollution treated in waste water treatment stations is characterized by the nature of its content, be this of mineral matter, carbon, nitrogen or phosphorus, and of its form, be this particulate, colloidal or dissolved.

The primary treatment of waste water consists of separating the particulate fraction of the pollution by means of a physical action, in some cases supplemented by a chemical action.

In the prior art, there are three main types of separators of the particulate fraction: decanters, flotation units and primary filtration.

The use of decanters may be purely physical or enriched by reagents of chemical or organic origin, allowing better interception of the colloidal pollution. The floc formed by the addition of reagents may, in certain technologies, be ballasted in order to obtain a more compact working size.

The use of flotation units may include the addition of reagents (coagulant and/or flocculation agents) and an agent ensuring flotation (microbubbles of air for example).

The primary filtration may include the addition of chemical reagents in order to improve the capture of the colloidal pollution.

The choice of technology depends on a number of parameters: the desired output water quality, the ground area available, the cost of construction of the equipment, the cost of operation, the technicality required for operation, the equipment or type of treatment plant downstream, or the availability of reagents on site.

The majority of these technologies are mature and have a great wealth of experience, allowing their performance and application limits to be easily quantified.

However, apart from dissolved phosphorus which may be precipitated by the addition of metal salts, the facilities currently available for primary treatment can only eliminate the particulate and colloidal fractions of the pollution. The dissolved fraction cannot be treated by these methods, and a secondary stage must be applied in order to be able to eliminate this.

Therefore, the efficiency of elimination of pollution by these technologies is essentially determined by the non-soluble fraction of the pollution.

In the prior art, several systems are available which combine an existing physical or physicochemical separator with prior treatment of the carbonated dissolved pollution.

For example, a conventional method consists of combining a conventional clarifier with prior treatment by high-load activated sludge. This method gives good degradation of the dissolved and particulate pollution, but the treatment of the extracted sludge is not satisfactory. Another drawback is that the facility for implementing this method requires a large ground area connected with the installation of a clarifier.

The combination of MBBR (Moving Bed Biofilm Reactor) technology with a decanter or flotation unit leads to a compact facility with good degradation of the dissolved pollution, and better treatment of the extracted sludge. However, the energy consumption of the MBBR technology is very high because of the need for permanent air blasting.

Consequently, there is a need to provide a compact and efficient facility with low energy demand, which can effectively eliminate both the particulate and colloidal fractions and the dissolved fraction of the pollution.

It is an object of one aspect of the present invention to remedy this technical deficiency and propose a novel facility for treating waste water of municipal or industrial origin, in particular primary water.

The facility according to the invention comprises a biological contact tank (1) equipped with biological rotating discs (8), which is connected upstream of a ballasted-floc physiochemical decanter (2), said decanter comprising at least a coagulation zone (3), a flocculation zone (4), a lamellar decanting zone (5), a thickening zone (6) and an external circuit (7) allowing the recirculation of the sludge thickened in the thickening zone (6) to the flocculation zone (4) and said biological contact tank (1).

The term “waste water of municipal or industrial origin” means water contaminated with pollutants liable to harm the natural environment and human health, resulting from human activity, in particular domestic or industrial.

The term “primary water” means water treated by a primary treatment as defined above.

The biological contact tank (1) combined with the biological rotating discs (3) allows the development of two types of biomass within the tank: a free biomass in the form of activated sludge, and a biomass fixed to the biological rotating discs (8). This system firstly allows breakdown of part of the dissolved and particulate pollution by physical adsorption on the recirculated floc from the primary decanter, and secondly elimination of the soluble fraction of the carbonated pollution not adsorbed by the biomass.

The two types of biomass, free and fixed, consist of heterotrophic bacteria which use the easily biodegradable carbon in the untreated water for their growth.

The culture fixed to the rotating discs ensures a very rapid start-up in the case of an increase in load, allowing adaptation of the number of discs as a function of the load received.

The ballasted-floc physicochemical decanter placed downstream of the biological contact tank allows separation of the treated water not only from the body of particulate pollution contained in the untreated water, but also from the sludge produced by degradation of the dissolved carbonated pollution achieved by the biological rotating discs. The decantability of the sludge produced by the biomass of the contact tank is ensured by the addition of coagulant in the coagulation zone (3) and by the addition of polymer in the flocculation zone (4).

The ballasted-floc physicochemical decanter (2) of the facility of the invention plays three roles complementary to those of the biological contact tank:
coagulation of the colloidal pollution not adsorbed by the floc of the contact tank,
ensuring good flocculation of the bacteria formed on purification by free biomass in the contact tank, this flocculation not being possible in the biological contact tank because of the age of the sludge which is applied too young and of the absence of reagents,
separation of the floc formed from the purified water in the lamellar decanter.

The sludge thickened in the thickening zone (6) of the decanter is recirculated to the flocculation zone (4) and said biological contact tank (1), which allows regeneration of the free biomass involved in purification of the dissolved pollution, and recirculation of the still active polymer in order to facilitate the adhesion of the free biomass on the biological rotating discs.

The ballasted-floc physicochemical decanter (2) may be any decanter of this type known in the prior art, in particular a Densadeg® decanter.

In order to maximize the energy potential of the untreated water, in particular the potential for methane production by the digestions of sludge extracted at the base of the thickening zone (6) of the decanter (2), the untreated water is held in the biological contact tank for a very short contact time, in order to treat only the dissolved part of the organic pollution which is most easily biodegradable.

The person skilled in the art will be able to calculate the volume of the biological contact tank taking into account the volume of untreated water to be treated and the contact time of the untreated water in said contact tank.

According to a particular embodiment, the biological contact tank (1) has a volume allowing a contact time of the untreated water in said contact tank to be less than 20 minutes, advantageously between 10 and 20 minutes.

The distribution of recirculation between the flocculation zone (4) and the biological contact tank (1) can be parameterized and adjusted by the user. Typically, the ratios of recirculated flow between the flocculation zone (4) and the biological contact tank (1) are around 30% of flow directed to the flocculation zone (4) and 70% to the biological contact tank (1), or vice versa.

The particulate carbonated fraction is left intact for digestion, whereas the dissolved part is degraded into a very young biological sludge which is easily fermentable. The age of sludge obtained for the free biomass is thus very low, less than 0.5 hours, in order to limit as far as possible the oxygen consumption linked to bacterial respiration.

In contrast to other biological reactor technology which requires a greater quantity of oxygen and permanent air blasting, because of the reduced contact time, the oxygen demand of the free and fixed biomass in the contact tank is very low. The oxygen necessary for treatment of the carbonated pollution dissolved in the untreated water may be supplied solely by the rotation of the biological discs. Consequently, the energy demand of the rotating discs is also very low.

According to another particular embodiment, the number and size of the biological rotating discs (8) in the biological contact tank (1) are a function of the load of dissolved carbonated pollution.

Typically, the biological contact tank (1) of the facility of the present invention allows elimination of between 20 and 40 g of soluble DBO₅ per m² of disc and per day.

In a more particular embodiment, said biological contact tank (1) comprises a means for measuring the concentration of dissolved oxygen in the biological contact tank (1), in particular a sensor immersed in said tank.

In another more particular embodiment, said biological contact tank (1) comprises a means for measuring the concentration of solid matter in said tank.

In another more particular embodiment, said decanter (2) comprises a means for measuring the recirculation flow of the thickened sludge.

In another embodiment, said biological contact tank (1) is confined.

The facility of the invention may be implemented for various industrial applications, in particular for:
renovation of an existing station for pretreating the incoming pollution, and increasing its capacity, both in quantity (possibility of eliminating more DBO₅) and in quality (adaptation of an existing heavy-load station for treatment of carbon and treatment of nitrogen),
decentralized treatment of storm drains to attenuate the discharge of pollution towards the natural environment,
integration in the first stage of treatment in order to eliminate the organic carbon and thus promote the downstream treatment by anammox bacterial flora,
the treatment of industrial effluent, very rich in dissolved organic carbon.

Thanks to its very compact form, the facility according to the invention may be inserted in containers for treatment of waste water.

Another aspect of the invention is to propose a method for treating waste water of municipal or industrial origin, in particular a method for primary treatment of water by a facility according to the invention.

Said method comprises the following steps:
injecting untreated water into the biological contact tank (1) equipped with biological rotating discs (8),
holding the untreated water in said tank (1) for a contact time of less than 20 minutes in order to eliminate the dissolved pollution,
injecting the water from the biological contact tank (1) into the decanter (2) of said facility and holding it there in order to eliminate the particulate and colloidal pollution,
extracting the treated water from the lamellar decanting zone (5) and the thickened sludge from the thickening zone (6),
where applicable, recirculating part of the thickened sludge to the flocculation zone (4) and said contact tank (1).

According to a particular embodiment of the method of the invention, the concentration of solid matter in the biological contact tank (1) is held at 1 g/L to 2 g/L in order to promote the formation of biological floc while observing the limit mass flows applicable to the decanter.

According to another particular embodiment of the method of the invention, the recirculation flow of the thickened sludge to the biological contact tank (1) is between 3% and 10% of the flow of untreated water. This recirculation allows a free biomass to be kept in activity.

The recirculation of sludge from the base of the decanter (2) may be controlled by a means for measuring the concentration of solid matter in the biological contact tank (1). The recirculation flow may be controlled by a flow-measuring means installed in the decanter (2).

Since the sludge in the decanter is thickened, the sludge recirculation rate is very low.

Extraction of the surplus sludge is controlled by managing the sludge blanket in the decanter, in particular by means of a sludge blanket detector sensor.

According to another particular embodiment of the method of the invention, the rotation speed of the discs (8) is a function of the concentration of dissolved oxygen in the biological contact tank (1) and of the quantity of biomass fixed to the discs.

The dissolved oxygen in the biological contact tank (1) may be measured by a means for measuring the concentration of dissolved oxygen, in particular a sensor immersed in said tank.

The quantity of biomass fixed to the discs is measured via the power consumed at the level of the disc drive shaft.

Typically, the concentration of dissolved oxygen to be maintained in the biological contact tank (1) is between 0.2 and 1 mg/L dissolved oxygen.

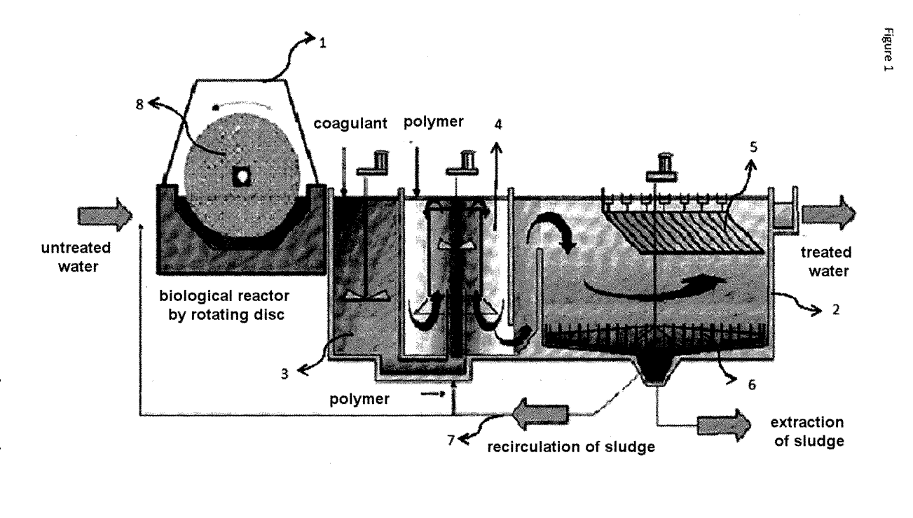

The invention is further illustrated by FIG. 1 and the examples below.

FIG. 1 shows a facility of the invention which consists of a biological contact tank (1) equipped with biological rotating discs (8), connected upstream of a ballasted-floc physicochemical decanter (2), said decanter comprising at least a coagulation zone (3), a flocculation zone (4), a lamellar decanting zone (5), a thickening zone (6) and an external circuit (7) allowing recirculation of the sludge thickened in the thickening zone (6) towards the flocculation zone (4) and/or said biological contact tank (1).

### EXAMPLES

### 1. Exemplary Embodiment

A facility of the invention is implemented for the treatment of a municipal waste water corresponding to 50,000 eh.

The untreated water flow to be treated is 10,000 m3/d. The peak coefficient is 2.

The pollutant load of this untreated water is specified in table 1 below.

TABLE 1

| Load | |
|---|---|
| DCO kg/d | 6000 |
| DBO kg/d | 3000 |
| MES kg/d | 3100 |
| NTK kg/d | 500 |
| PT kg/d | 100 |

The totality of oxidizable pollutants present in the untreated water is represented by DCO (chemical oxygen demand). The biodegradable carbonated organic pollution in the untreated water is represented by DBO (biochemical oxygen demand). The MES value (suspended matter) corresponds to the quantity of elements in suspension in the untreated water. The NTK value corresponds to the quantity of nitrogen in organic or ammoniacal form in the untreated water (total Kjeldahl nitrogen). The PT value corresponds to the quantity of total phosphorus, comprising particulate phosphorus and dissolved phosphorus.

The treatment using a facility of the invention is compared with treatment by a “Densadeg” type physicochemical decanter alone.

The main characteristics of the two treatment methods are shown in table 2 below:

TABLE 2

| | | Method by | |
|---|---|---|---|
| | | the facility | |
| | | of the | Method by |
| | | invention | “Densadeg” ® |
| Volume | Decanter | 391 m³ | 391 m³ |
| | Biological contact | 80 m³ | |
| | tank | | |

| | | |
|---|---|---|
| Total ground area | 99 m² | 79 m² |
| MES discharge (mg/L) | 30.0 | 50.3 |
| DBO discharge (mg/L) | 75.6 | 146.0 |
| | Reduction of | Reduction of |
| | 75% | 48% |
| DCO discharge (mg/L) | 159 | 249 |
| Nitrogen discharge (mg/L) | 42.7 | 42.1 |
| N—NH₄ | 40.2 | 95.3 |
| N—NO₃ | 0.0 | 0.0 |
| Phosphorus discharge (mg/L) | 4.9 | 6.3 |
| P-PO₄ (mg/L) | 4.4 | 5.6 |

In comparison with the ballasted-floc physicochemical decanter, the facility of the invention offers a significant improvement for the elimination of suspended matter (MES), of oxidizable organic pollution and of biodegradable carbonated organic pollution.

### 2. Mass Balance of the Facility of the Invention

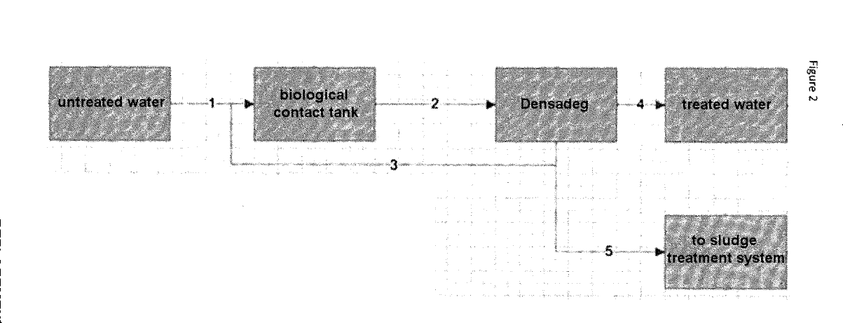

FIG. 2 and table 3 below illustrate a mass balance of the facility of the invention. The balance is produced for a conventional European untreated water for which the MES value is 310 mg/L and the DBO₅ value is 300 mg/L. The flow of untreated water entering a biological contact tank, the flow leaving said tank and entering a decanter, the recirculation flow leaving said decanter and entering the contact tank, the flow of treated water leaving said decanter, and the flow of sludge leaving said decanter, are numbered respectively as flows 1, 2, 3, 4 and 5.

TABLE 3

| | | MES concentration | DBO concentration |
|---|---|---|---|
| Flow | Flow rate | g/L | Mg/L |
| 1 | Q | 0.3 | 300 |
| 2 | 107.5% XQ | 2 | 195 |
| 3 | 7.5% XQ | 25 | |
| 4 | 99% XQ | 0.02 | 30 |
| 5 | 1% XQ | 25 | |

The facility of the invention allows elimination of 90% of particulate pollution and biodegradable carbonated organic pollution.

1. A facility for treating waste water of municipal or industrial origin, in particular a facility for primary treatment of said water, comprising a biological contact tank (1) equipped with biological rotating discs (8), which is connected upstream of a ballasted-floc physiochemical decanter (2), said decanter comprising at least a coagulation zone (3), a flocculation zone (4), a lamellar decanting zone (5), a thickening zone (6) and an external circuit (7) allowing the recirculation of the sludge thickened in the thickening zone (6) to the flocculation zone (4) and said biological contact tank (1).

2. The facility as claimed in claim 1, wherein the biological contact tank (1) has a volume allowing a contact time of the untreated water in said contact tank to be less than 20 minutes, advantageously between 10 and 20 minutes.

3. The facility as claimed in claim 1, wherein the number and size of the biological rotating discs (8) in the biological contact tank (1) are a function of the load of dissolved carbonated pollution.

4. The facility as claimed in claim 1, wherein said biological contact tank (1) comprises a means for measuring the concentration of dissolved oxygen in the biological contact tank (1), in particular a sensor immersed in said tank.

5. The facility as claimed in claim 1, wherein said biological contact tank (1) comprises a means for measuring the concentration of solid matter in said tank.

6. The facility as claimed in claim 1, wherein said decanter (2) comprises a means for measuring the recirculation flow of the thickened sludge.

7. The facility as claimed in claim 1, wherein said biological contact tank (1) is confined.

8. A method for treating waste water of municipal or industrial origin, in particular a method for primary treatment of water by a facility as defined in claim 1, comprising the following steps:
injecting untreated water into the biological contact tank (1) equipped with biological rotating discs (8) of said facility,
holding the untreated water in said tank (1) for a contact time of less than 20 minutes in order to eliminate the dissolved pollution,
injecting the water from the biological contact tank (1) into the decanter (2) of said facility and holding it there in order to eliminate the particulate and colloidal pollution,
extracting the treated water from the lamellar decanting zone (5) of said facility and the thickened sludge from the thickening zone (6),
where applicable, recirculating part of the thickened sludge to the flocculation zone (4) and said contact tank (1).

9. The method as claimed in claim 8, wherein the concentration of solid matter in the biological contact tank (1) is held at 1 g/L to 2 g/L.

10. The method as claimed in claim 8, wherein the recirculation flow to the biological contact tank (1) is between 3% and 10% of the flow of untreated water.

11. The method as claimed in claim 8, wherein the rotation speed of the discs (8) is a function of the concentration of dissolved oxygen in the biological contact tank (1) and of the quantity of biomass fixed to the discs.

12. The facility as claimed in claim 2, wherein the number and size of the biological rotating discs (8) in the biological contact tank (1) are a function of the load of dissolved carbonated pollution.

13. The facility as claimed in claim 2, wherein said biological contact tank (1) comprises a means for measuring the concentration of dissolved oxygen in the biological contact tank (1), in particular a sensor immersed in said tank.

14. The facility as claimed in claim 3, wherein said biological contact tank (1) comprises a means for measuring the concentration of dissolved oxygen in the biological contact tank (1), in particular a sensor immersed in said tank.

15. The facility as claimed in claim 2, wherein said biological contact tank (1) comprises a means for measuring the concentration of solid matter in said tank.

16. The facility as claimed in claim 3, wherein said biological contact tank (1) comprises a means for measuring the concentration of solid matter in said tank.

17. The facility as claimed in claim 4, wherein said biological contact tank (1) comprises a means for measuring the concentration of solid matter in said tank.

18. The facility as claimed in claim 2, wherein said decanter (2) comprises a means for measuring the recirculation flow of the thickened sludge.

19. The facility as claimed in claim 3, wherein said decanter (2) comprises a means for measuring the recirculation flow of the thickened sludge.

20. The facility as claimed in claim 4, wherein said decanter (2) comprises a means for measuring the recirculation flow of the thickened sludge.
